(19) United States
(12) Patent Application Publication
(10) Pub. No.: US 2004/0153269 A1
(43) Pub. Date: Aug. 5, 2004

(54) Automated data capture system

(76) Inventor: Frank Joseph Kalas JR., Burke, VA (US)

Correspondence Address: STAAS & HALSEY LLP, SUITE 700, 1201 NEW YORK AVENUE, N.W., WASHINGTON, DC, 20005, US

(21) Appl. No.: 10/075,594

(22) Filed: Feb. 15, 2002

Related U.S. Application Data
(60) Provisional application No. 60/268,856, filed on Feb. 16, 2001.

(51) Int. Cl. G06F 19/00

(52) U.S. Cl. 702/81

(57) ABSTRACT

An automated data capture system including mobile terminals brought by inspectors to an inspection vicinity of an end-item. The inspectors inspect components of the end-item and enter resulting inspection data into the terminals. The entered inspection data is electronically transferred to a database system which correlates and maintains the inspection data for the end-item.

### CROSS-REFERENCE TO RELATED APPLICATIONS

This application claims priority to U.S. provisional application entitled Automated Data Capture System having serial No. 60/268,856, filed Feb. 16, 2001, and which is incorporated herein by reference herein.

### BACKGROUND OF THE INVENTION

1. Field of the Invention

The present invention relates to data collection, validation, maintenance and reporting, and more particularly to discrepancy or disposition and maintenance condition data collection, validation, maintenance and reporting.

2. Description of the Related Art

Identifying and controlling the current status and configuration of any structure or object such as, but not limited to, an aircraft, seagoing vessel, ground vehicle, power plant or any other inventory of equipment used for military or commercial purposes is crucial to the continued proper functioning of that object.

For example, monitoring and properly maintaining an aircraft throughout its life cycle is crucial to ensure airworthiness and safety. The complete structure of an aircraft along with all its components needs to be identified and documented. Such identification and documentation requires the use of information including, in part, component numbers, serial numbers, life limits, performance measures, and service bulletin status. The individual systems and components that make up the aircraft need to be tracked throughout their complete life cycle to ensure reliability. For example, the current status/condition of each component of an aircraft is typically documented during a process known as Examination and Evaluation.

Existing discrepancy data collection systems often use a “Discrepancy Book,” which is a hard copy list of most possible problems associated with a particular object, from mechanical or electronics problems to corrosion or surface paint issues. When examining an object, Examination and Evaluation personnel hand write annotations to discrepancies listed in the Discrepancy Book for any discrepancies found on the object. For each discrepancy found, Maintenance Personnel must decide to fix the discrepancy immediately, or to defer the fix until a later date. If it is decided that the problem is to be fixed, maintenance personnel initiate corrective action on logged discrepancies. Otherwise, authorized staff may transfer tasks to a deferred item list in the Discrepancy Book, if the reported problem does not affect the effectiveness of the object.

A discrepancy data collection systems using a hard copy Discrepancy Book with handwritten notations can be referred to as a “manual” discrepancy data collection system.

Some discrepancy data collection systems use a Discrepancy Book made available in an electronic format. Annotations are made to the electronic format Discrepancy Book using a desktop computer at a remote location from the object. A discrepancy data collection system using an electronic format Discrepancy Book with notations made by a computer at a remote location from the object can be referred to as an “electronic” discrepancy data collection system.

There are several problems with existing manual and electronic discrepancy data collection systems.

For example, generally, existing systems are slow, inefficient and prone to error.

Moreover, manual systems require the Examination and Evaluation Personnel to hand write annotations into the Discrepancy Book. This causes interpretation issues if the handwriting is unreadable, faded, blurred or incoherent.

Further, annotations to Standard Discrepancies from the Discrepancy Book leave room for various interpretations. For example, different Examination and Evaluation Personnel may choose to word annotations in a different way, causing a potential for misinterpretation of the annotation.

In addition, annotations as written by the Examination and Evaluation Personnel are not restricted to currently established reference data. As such, incorrect data may go unnoticed until it is too late to be corrected.

Once the Examination and Evaluation Personnel has finished their inspection of the object, they must now re-organize their findings and prepare work order documentation for the artisans or mechanics to work from. The Examination and Evaluation Personnel are responsible for determining the appropriate reference data (engineering documentation, repair shop numbers, malfunction codes etc.) for the discrepancy they are writing. However, this requires time consuming research and the referencing of several documents for routine discrepancies.

Further, reporting of handwritten discrepancies is a tedious and labor-intensive prospect in a manual system. Each report must be researched from the Discrepancy Book and data must be collected and collated manually.

Moreover, sharing data with both internal and external systems must be done through the creation of extensive reports in a paper form. This process causes significant delays in data sharing, and also allows only exclusive use of the data. For example, each dataset can only be reviewed by a single person at any given time.

Further, electronic discrepancy data collection systems are typically available on a desktop computer, attached via a hardwire connection to a supporting Local Area Network. This non-mobile system requires that the Examination and Evaluation Personnel perform their inspection with pen and paper, and then transcribe their findings at their desk or workbench. This “double entry” system promotes transcription errors, and inefficient use of the inspectors' time. If, for example, the inspector is required to verify something on the object during the data entry process, the inspector must return to the object without his/her data entry mechanism.

In addition, most electronic systems for collecting maintenance data involve many screens and complex commands. The user must thoroughly understand the complex process flow to enter and retrieve data from these systems.

### SUMMARY OF THE INVENTION

Accordingly, it is an object of the present invention to provide a system for use by Examination and Evaluation Personnel which improves the collection, storage, analysis and sharing of maintenance data.

More specifically, it is an object of the present invention to provide an automated data capture system (ADCS) which tracks discrepancy data electronically, providing clear, concise and easy to read characters.

It is also an object of the present invention to provide an ADCS which uses standard and agreed upon annotations, thereby decreasing the potential for the misinterpretation of data.

In addition, it is an object of the present invention to provide an ADCS which maintains reference data, and will not allow the user to enter values that are not part of a standard reference data set as outlined by a standards body. Thus, data is consistent throughout the life of the inspection program.

Further, it is an object of the present invention to provide an ADCS which electronically sends captured data to a Work Document generation application, significantly decreasing the amount of time necessary to commence work on defects.

It is an additional object of the present invention to provide an ADCS which collects and maintains historical reference data, and can run standard reports from this data in minutes. The time taken to create reports will thereby be decreased significantly.

It is a further object of the present invention to provide an ADCS which, through one-time, prior research, already contains information for standard discrepancies, allowing the Examination and Evaluation Personnel to spend more time inspecting, and less time searching for data on standard discrepancies.

It is an object of the present invention to provide an ADCS which allows for the electronic transfer of data to both internal and external systems, and for the review of ADCS data by multiple people at any given time.

It is an object of the present invention to provide an ADCS which can be installed on a mobile computing device that can be taken to the inspected object for immediate data entry.

It is an object of the present invention to provide an ADCS which is fast, efficient, accurate, and targeted to the language of the user and to the type of user operating the system, to thereby greatly increase the efficiency and reliability of the inspection process.

Additional objects and advantages of the invention will be set forth in part in the description which follows, and, in part, will be obvious from the description or may be learned by practice of the invention.

The foregoing objects of the present invention are achieved by providing an automated data capture system including (a) terminals located in an inspection vicinity of an end-item formed of different components, inspectors inspecting the components and entering resulting inspection data into the terminals; and (b) a database system, the entered inspection data from each of the inspectors being electronically transferred to the database system and correlated and maintained by the database system as inspection data for the end-item.

Objects of the present invention are also achieved by providing an automated data capture system including (a) a first mobile terminal for a first inspector, the first inspector inspecting components of an end-item in an order selectable by the first inspector, inspection of a respective component by the first inspector resulting in inspection data which is directly entered into the first mobile terminal in an inspection vicinity of the component by the first inspector; (b) a second mobile terminal for a second inspector, the second inspector inspecting components of the end-item in an order selectable by the second inspector, inspection of a respective component by the second inspector resulting in inspection data which is directly entered into the second mobile terminal in an inspection vicinity of the component by the second inspector; and (c) a database system, the entered inspection data from the first and second inspectors being electronically transferred to the database system and correlated and maintained by the database system as inspection data for the end-item.

Moreover, objects of the present invention are achieved by providing an automated data capture system including (a) an information adder; (b) a first mobile terminal for a first inspector, the first mobile terminal operable with the information adder to allow the first inspector to select a component of an end-item for which the first inspector will enter inspection data while in an inspection vicinity of the selected component, wherein, after the first inspector selects a component, the information adder automatically provides an electronically selectable list of standard discrepancies for the selected component to the first inspector via the first mobile terminal, the first inspector then electronically selecting a standard discrepancy from the list while in the inspection vicinity to thereby enter the standard discrepancy as inspection data indicating that the standard discrepancy was found during an inspection of the selected component; (c) a second mobile terminal for a second inspector, the second mobile terminal operable with the information adder to allow the second inspector to select a component of the end-item for which the second inspector will enter inspection data while in an inspection vicinity of the selected component, wherein, after the second inspector selects a component, the information adder automatically provides an electronically selectable list of standard discrepancies for the selected component to the second inspector via the second mobile terminal, the second inspector then electronically selecting a standard discrepancy from the list while in the inspection vicinity to thereby enter the standard discrepancy as inspection data indicating that the standard discrepancy was found during an inspection of the selected component; and (d) a database system, the entered inspection data from the first and second inspectors being electronically transferred to the database system and correlated and maintained by the database system as inspection data for the end-item.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a diagram illustrating an automated data capture system (ADCS) according to an embodiment of the present invention.

FIG. 2 is a diagram illustrating details of an end-item module and a component module of an ADCS, according to an embodiment of the present invention.

FIG. 3 is a diagram illustrating an add discrepancy information process, according to an embodiment of the present invention.

FIG. 4 is a diagram illustrating the operation of a modify discrepancy information process and a view discrepancy information process, according to an embodiment of the present invention.

FIG. 5 is a diagram illustrating a delete discrepancy information process, according to an embodiment of the present invention.

FIG. 6 is a diagram illustrating a duplicate discrepancy information process, according to an embodiment of the present invention.

FIG. 7 is a diagram illustrating an approve/un-approve discrepancy information process, according to an embodiment of the present invention.

FIG. 8 is a diagram illustrating the operation of an export process for exporting end-item discrepancy information and component discrepancy information to a work packaging system, according to an embodiment of the present invention.

FIG. 9 is a diagram illustrating details of a power plant module of an ADCS, according to an embodiment of the present invention.

FIG. 10 is a diagram illustrating a power plant induction process, according to an embodiment of the present invention.

FIG. 11 is a diagram illustrating a power plant disposition process, according to an embodiment of the present invention.

FIG. 12 is a diagram illustrating a Log Set verification process, according to an embodiment of the present invention.

FIG. 13 is a diagram illustrating a documentation verification process, according to an embodiment of the present invention.

FIG. 14 is a diagram illustrating operation of a close power plant induction process, according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

Various terms are used in the description of the present invention, and are defined as follows.

A “discrepancy” is defined as a defect or potential defect of any part of an object being inspected.

A “condition” is defined as the current state at a specific location of the object being inspected. For example, the current condition of a metal component of the object may be “significantly corroded”.

A “defect” is defined as a condition that no longer fits within the tolerable parameters of an inspection specification.

An “end-item” is defined as the overall object being inspected.

A “component” is defined as a part of the end-item being inspected.

A “power plant” is defined as the engine or mechanism which creates energy used by the end-item.

It is believed that each of the above definitions would be well understood by a person of ordinary skill in the art, especially in view of the disclosure herein.

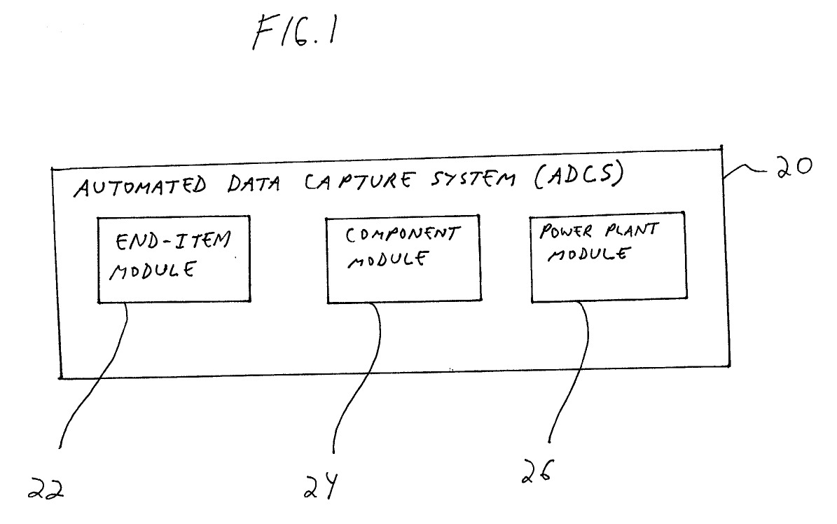

FIG. 1 is a diagram illustrating an automated data capture system (ADCS) according to an embodiment of the present invention. Referring now to FIG. 1, an ADCS 20 includes an end-item module 22, a component module 24 and a power plant module 26.

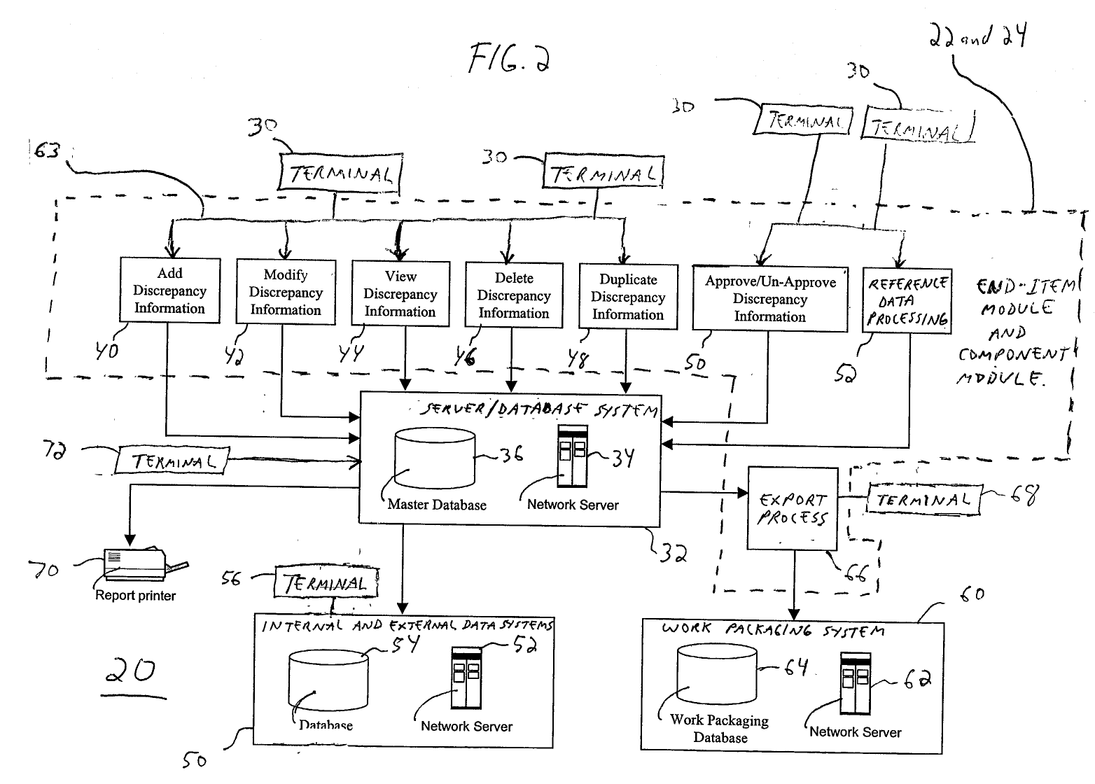

FIG. 2 is a diagram illustrating details of end-item module 22 and component module 24 of ADCS 20, according to an embodiment of the present invention. Referring now to FIG. 2, users access terminals 30 to examine and evaluate discrepancy and related engineering data. Each terminal 30 might be, for example, a desktop computer, a mobile computer (such as, but not limited to, a Fujitsu ST series computer), a palm-type device, or some other type of terminal. Therefore, in a typical embodiment, each user might have his/her own mobile computer operating as terminal 30. Although FIG. 2 shows only two terminals 30, the present invention is not limited to any particular number of terminals 30 or any particular number of users. Therefore, there might be a plurality of users having a plurality of terminals 30, respectively. The plurality of terminals 30 might include, for example, various desktop computers, mobile computers, palm-type devices and/or other types of terminals.

A server/database system 32 includes a network server 34 and a master database 36. Via a respective terminal 30, a user can execute various processes. Such processes include, for example, an add discrepancy information process 40, a modify discrepancy information process 42, a view discrepancy information process 44, a delete discrepancy information process 46 and a duplicate discrepancy information process 4 8. Various other terminals 30 might be able to execute an approve/un-approve discrepancy information process 50 and a reference data processing process 52. However, in a typical embodiment, not all users will have authorization to provide approvals/un-approvals, or to process reference data. Therefore, some or all of the users that are allowed to access discrepancy information process 40, modify discrepancy information process 42, view discrepancy information process 44, delete discrepancy information process 46 and duplicate discrepancy information process 48 might not be allowed to access approve/un-approve discrepancy information process 50 and/or reference data processing process 52.

Internal and external data systems 50 each have an associated network server 52 and database 54 operable with server/database system 32. Internal and external data systems 50 would typically be operable by associated terminals 56 which might be, for example, a desktop PC. Of course, terminals 56 are not limited to being a desktop PC, and could be virtually any type of terminal. Internal and external data systems 50 might also be accessible by terminals 30.

A work packaging system 60 has an associated network server 62 and a work packaging database 64. Data from server/database system 32 can be exported to work packaging system 60 via an export process 66. Work packaging system 60 can then automatically generate work orders from the exported data. Here, “automatically” indicates that the work orders are generated by a computer from the exported data. Export process 66 would typically be run via an associated terminal 68 which might be, for example, a desktop PC. Of course, terminals 68 are not limited to being a desktop PC, and could be virtually any type of terminal. Export process 66 might also be run by terminals 30. In some embodiments, work packaging system 60 might interact with ADCS 20 to provide the necessary information to permit audits in both work packaging system 60 and/or ADCS 20.

Reports might also be printable via a report printer 70. A respective terminal 72 might be connected to server/database system 32 for the purpose of printing reports via report printer 70. Reports might also be printable on report printer 70 via terminals 30.

As indicated above, a user might typically use a mobile computer or terminal to access the ADCS. Advantageously, the mobile computing environment allows a user to access all ADCS functionality in a near real-time environment as the user moves around the object. Using dynamically populated dropdown lists on the screen display of the users terminal, the inspector of a particular object is able to record the location, type and extent of discrepancies found during the Examination and Evaluation Process.

While using the mobile computing device, Examination and Evaluation Personnel enter data to the storage unit (i.e.: hard drive) of the mobile computing device. Once the Examination and Evaluation Personnel have completed their discrepancy data entry, they may electronically transfer this data over wired or wireless network technology to server/database system 32. Once the data has been transferred to network server 34, the discrepancy information is available on the users' desktop. In a typical embodiment, all data entered on the desktop might be entered directly to server/database system 32.

As can be seen from FIG. 2, Administrative Personnel can export data from network server 34 to internal and external data systems 50 and work packaging system 60. Data validation is performed to ensure that internal and external data systems 50 and work packaging system 60 will accept the exported data.

Users can print reports, view reports on-screen, and save reports in multiple formats, including but not limited to Microsoft Word. A user may, for example, request that reports be generated listing all discrepancies related to a user specified malfunction code, listing all fuel leak discrepancies, and/or listing all parts missing on inspection.

A user may choose to print and/or save a report. For example, a user may choose to print a report to report printer 70, view a report on a viewing device such as a computer monitor, and/or save the report as a word processing or other type of data file. Further, a user may choose to produce a report specific to a object's specific program reporting needs.

FIG. 2 shows a computer communication channel 63 through which terminals 30 communicate with the various processes. As should be understood from the above, computer communication channel 63 might use, for example, wireless, wired, electrical or optical communication technology, depending on the specific system architecture. However, the present invention is not limited to computer communication channel 63 being any specific type of technology.

Generally, the overall architecture in FIG. 2 is a client/server architecture. However, the present invention is not limited to this specific client/server architecture. For example, it may be possible for the various processes shown in FIG. 2 to be run on terminals 30, instead of being accessed by terminals 30 via computer communication channel 63. Therefore, various different “thin” and “thick” client/server architectures could be used to implement the present invention. Therefore, it should be understood that FIG. 2 represents only one possible architecture, and the present invention is not limited to this specific architecture. Instead, many variations are possible.

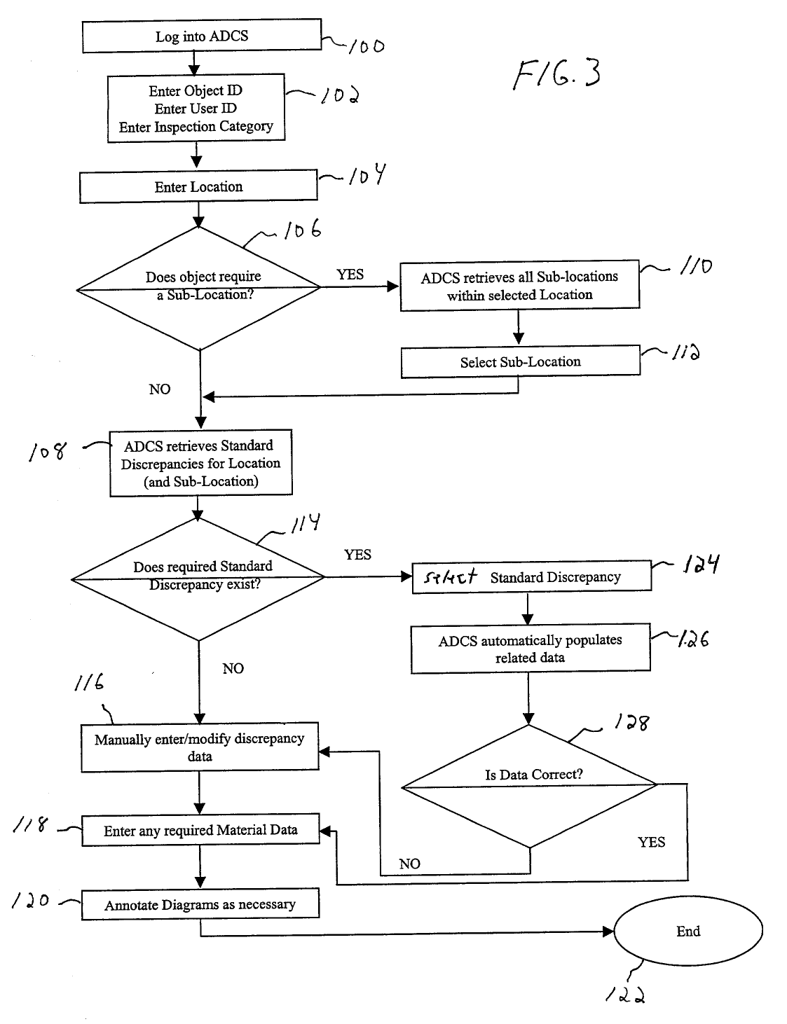

FIG. 3 is a diagram illustrating the add discrepancy information process 40 in FIG. 2, according to an embodiment of the present invention. The add discrepancy information process 40 can be executed by end-item module 22 and component module 24. Therefore, FIG. 3 depicts the addition of end-item or component discrepancy information for a given object.

Referring now to FIG. 3, in operation 100, the user (Examination and Evaluation Personnel) logs into the ADCS. From operation 100, the process moves to operation 102, where the user enters a user ID, an object ID and an inspection category. More specifically, the user chooses which object he/she wishes to enter discrepancy information for by the object ID. For accountability and tracking purposes, the user must identify himself/herself by providing a user ID. Finally, the user must identify which inspection category he/she is using to perform the inspection. Entering this data will identify the discrepancy information with an object and an inspector, and will tailor the available data to these selections.

From operation 102, the process moves to operation 104, where, to enter a new discrepancy, the user must enter the geographical location on the object where the discrepancy has been found. It may be necessary to enter a sub-location, if the object is broken down into sub-regions.

Therefore, from operation 104, the process moves to operation 106, where the ADCS determines whether there are sub-locations in the selected location. If there are not any sub-locations, the process moves to operation 108.

If there are sub-locations, the process moves from operation 106 to operation 110, where the ADCS retrieves all sub-locations within the selected location. From operation 110, the process moves to operation 112, where the user selections one of the sub-locations. From operation 112, the process moves to operation 108.

Once the user has entered the required location information, the remaining selectable data choices are updated to reflect only that data relating to the given location and sub-location. The result is that the user may only choose data values that are consistent with and appropriate for all previously chosen data.

In operation 108, the ADCS retrieves standard discrepancies for the location and sub-location. More specifically, a list of standard discrepancies is presented to the user for the location, sub-location and inspection category that the user has entered.

From operation 108, the process moves to operation 114, where the user determines whether an appropriate standard discrepancy exists in the list presented to the user. If an appropriate standard discrepancy exists in operation 114, the process moves to operation 124, where the user selects a standard discrepancy from those presented to the user. It may also be appropriate for the user to pick a standard discrepancy that is close to the required discrepancy.

From operation 124, the process moves to operation 126, where the ADCS automatically populates the related data. More specifically, when a standard discrepancy is chosen from the standard discrepancy list, the remaining discrepancy information is populated based on the pre-determined data relationships for this standard discrepancy.

From operation 126, the process moves to operation 128, where the user verifies whether populated data is correct. If the data is not correct, the process moves to operation 116, where the user can manually enter/modify discrepancy data. More specifically, the user may manually modify the data by selecting an item from, for example, an appropriate dropdown list, or typing the data in an appropriate text box. If the data is correct in operation 128, the process moves to operation 118.

If an appropriate standard discrepancy does not exist in operation 114, the process moves to operation 116, where the user can manually enter/modify discrepancy data. More specifically, if an appropriate standard discrepancy was not found in the standard discrepancy list, the user may manually enter the discrepancy information by choosing an item from an appropriate dropdown lists, and typing data in the appropriate text boxes. From operation 116, the process moves to operation 118.

In operation 118, the user enters any required material data. More specifically, the user may choose to add material requirements to the discrepancy information. This might happen, for example, when a part is required to correct the defect as outlined by the discrepancy. The user indicates that he or she wishes to include a material record, and enters the material information, for as many pieces of material as are required.

From operation 118, the process moves to operation 120, where diagrams can be annotated by the user as necessary. More specifically, the user may choose to add data to a set of available diagrams. This information will assist in further pinpointing the exact location of a defect. This information may not be required, but may be of some use to the user or other inspector.

From operation 120, the process moves to operation 122, where the process ends.

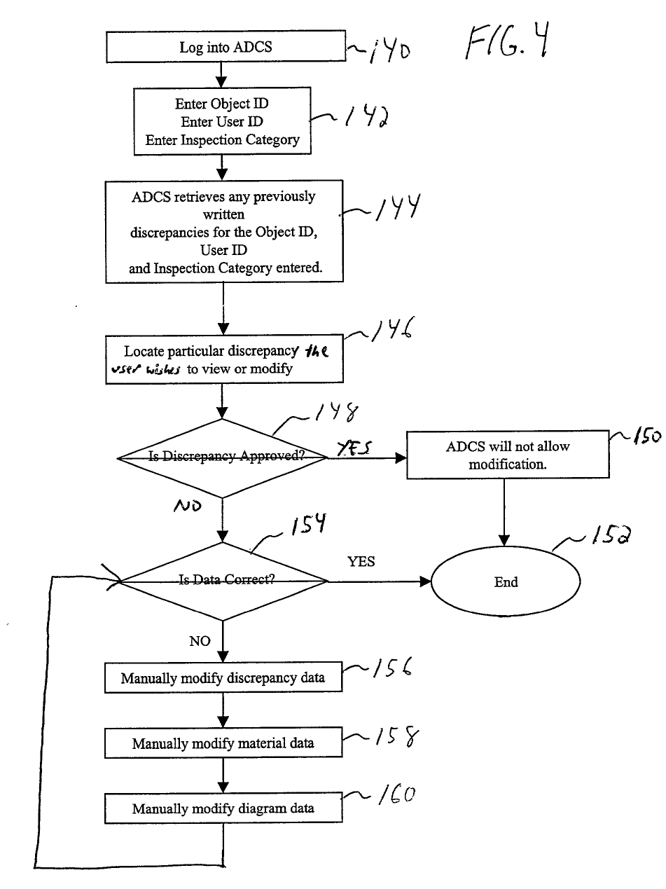

FIG. 4 is a diagram illustrating the combined operation of the modify discrepancy information process 42 and the view discrepancy information process 44 in FIG. 2, according to an embodiment of the present invention. The modify discrepancy information process 42 and the view discrepancy information process 44 can be executed by end-item module 22 and component module 24. Therefore, FIG. 4 depicts the modification/viewing of previously written end-item or component discrepancies for a given object.

Referring now to FIG. 4, in operation 140, the user logs into the ADCS.

From operation 140, the process moves to operation 142, where the user enters a user ID, an object ID and an inspection category. More specifically, the user chooses which object he/she wishes to view/modify discrepancy information for by the object ID. For accountability and tracking purposes, the user must identify himself/herself by providing a user ID. Finally, the user must identify which inspection category he/she used to perform the inspection and now wishes to view/modify.

From operation 142, the process moves to operation 144, where the ADCS retrieves any previously written discrepancies for the entered object ID, user ID and inspection category. More specifically, the ADCS will provide a view of all discrepancy information previously entered for the object identified by the object ID, written by the user identified by the User ID, and inspected under the inspection category identified.

From operation 144, the process moves to operation 146, where the user locates the particular discrepancy he/she wishes to view or modify. For example, the user may scroll through the data or use a find functionality to locate the particular discrepancy information the user wishes to view or modify. If modifications need to be made, the user may do so by, for example, selecting an item from the appropriate dropdown list, or typing the data in the appropriate text box.

Only discrepancy information that has not already been approved may be modified. Therefore, from operation 146, the process moves to operation 148, where the ADCS determines whether the discrepancy that the user wants to modify has been approved. If the discrepancy has been approved, the process moves to operation 150, where the ADCS will not allow the modification. From operation 150, the process moves to operation 152, where the process ends.

If the discrepancy has not been approved, the process moves from operation 148 to operation 154, where the user determines whether the modified data is correct. If the modified data is correct, the modification is entered and the process moves to operation 152, where the process ends.

If the modified data is not correct in operation 154, the process moves to operation 156, where the user can manually modify the discrepancy data.

From operation 156, the process moves to operation 158, where the user can manually modify other material data for the selected object.

From operation 158, the process moves to operation 160, where the user can manually modify diagram data for the selected object.

From operation 160, the process moves to operation 152, where the process ends.

Therefore, in FIG. 4, the user can choose to view or modify material requirements for a discrepancy. Moreover, in some embodiments of the present invention, when the user indicates that he or she wishes to view a material record, all the material information for this discrepancy is presented.

As can be seen from FIG. 4, only material data associated with a discrepancy that has not already been approved can be modified. Similarly, as can be seen from FIG. 4, only diagram data associated with a discrepancy that has not already been approved can be modified.

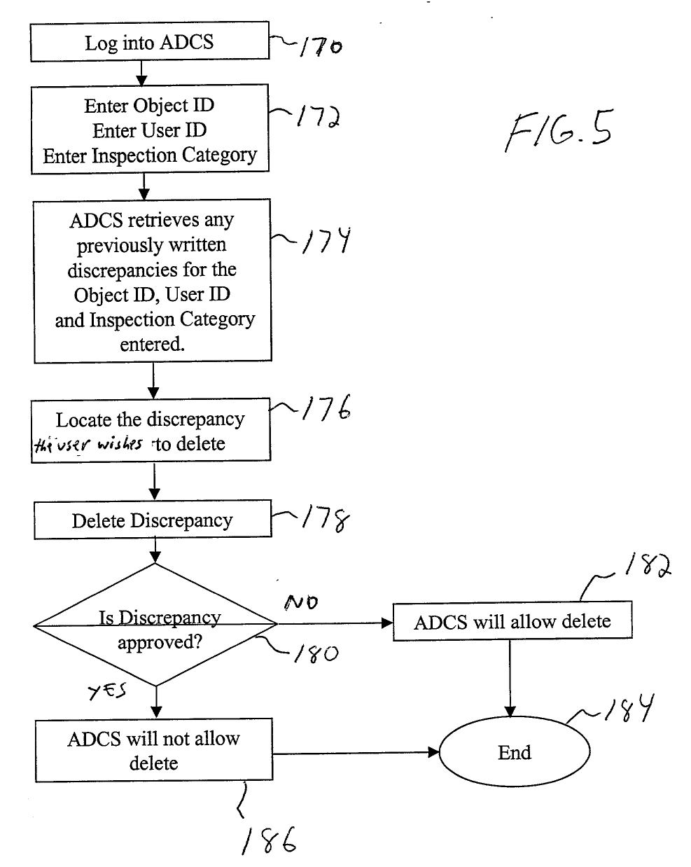

FIG. 5 is a diagram illustrating the delete discrepancy information process 46 in FIG. 2, according to an embodiment of the present invention. The delete discrepancy information process 46 can be executed by end-item module 22 and component module 24. Therefore, FIG. 5 depicts the deletion of previously written end-item or component discrepancies for a given object.

Referring now to FIG. 5, in operation 170, the user logs into the ADCS.

From operation 170, the process moves to operation 172, where the user enters a user ID, an object ID and an inspection category. More specifically, the user chooses which object he/she wishes to delete by the object ID. For accountability and tracking purposes, the user must identify himself/herself by providing a user ID. Finally, the user must identify which inspection category he/she used to perform the inspection and now wishes to delete.

From operation 172, the process moves to operation 174, where the ADCS retrieves any previously written discrepancies for the entered object ID, user ID and inspection category. More specifically, the ADCS will provide a view of all discrepancy information previously entered for the object identified by the object ID, written by the user identified by the air User ID, and inspected under the inspection category identified.

From operation 174, the process moves to operation 176, where the user may scroll through the data to locate and select the particular discrepancy information the user wishes to delete.

From operation 176, the process moves to operation 178, where the user indicates that the selected discrepancy information is to be deleted.

Only discrepancy information that has not already been approved can be deleted. Therefore, from operation 176, the process moves to operation 178, where it is determined whether the discrepancy has been approved.

If the discrepancy has yet to be approved, or was approved but then un-approved, the process moves from operation 180 to operation 182, where the ADCS allows the user to delete the discrepancy information.

From operation 182, the process moves to operation 184, where the process ends.

If the discrepancy has already been approved, the process moves from operation 180 to operation 186, where the ADCS will not allow the discrepancy information to be deleted.

From operation 186, the process moves to operation 184, where the process ends.

With the embodiment in FIG. 5, material information and diagram information associated with a deleted discrepancy is also deleted.

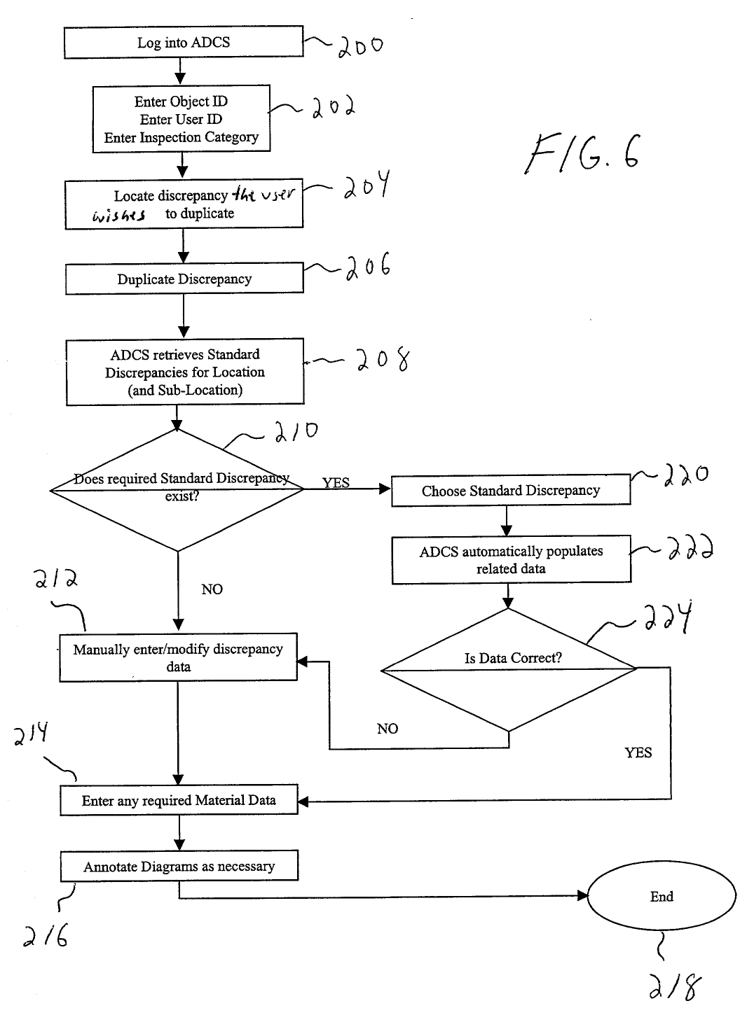

FIG. 6 is a diagram illustrating the duplicate discrepancy information process 48 in FIG. 2, according to an embodiment of the present invention. The duplicate discrepancy information process 48 can be executed by end-item module 22 and component module 24. Therefore, FIG. 6 depicts the duplication of previously written end-item or component discrepancies for a given object.

Referring now to FIG. 6, in operation 200, the user logs into the ADCS.

From operation 200, the process moves to operation 202, where the user enters a user ID, an object ID and an inspection category. More specifically, the user chooses which object he/she wish to duplicate by the object ID. For accountability and tracking purposes, the user must identify himself/herself by providing a user ID. Finally, the user must identify which inspection category he/she used to perform the inspection and now wishes to duplicate.

At this time, the ADCS presents a view of all discrepancy information previously entered for the object identified by the object ID, written by the user identified by the User ID, and inspected under the inspection category identified.

From operation 202, the process moves to operation 204, where the user locates the discrepancy the user wishes to duplicate. More specifically, for example, the user might scroll through the presented data or use a find functionality to locate the particular discrepancy information he/she wishes to duplicate.

From operation 204, the process moves to operation 206, where the discrepancy is duplicated. More specifically, when the user indicates that he/she wishes to duplicate a discrepancy, predetermined discrepancy information is copied to a new discrepancy record. The discrepancy description is left blank. Of course, this manner of duplicating a discrepancy represents only one embodiment of the present invention, and many variations are possible.

From operation 206, the process moves to operation 208, where the ADCS retrieves a list of standard discrepancies for the location, sub-location as indicated from the duplicated discrepancy, and the inspection category that the user entered. This list is then presented to the user.

From operation 208, the process moves to operation 210, where the user determines whether a standard discrepancy exists for the discrepancy the user wishes to duplicate.

If an appropriate standard discrepancy was not found in the standard discrepancy list, the process moves to operation 212, where the user may manually enter the discrepancy information by, for example, choosing an item from appropriate dropdown lists and/or typing data in appropriate text boxes.

From operation 212, the process moves to operation 214, where the user can enter any required material data.

From operation 214, the process moves to operation 216, where the user can annotate diagrams as necessary.

From operation 216, the process moves to operation 218, where the process ends.

If a standard discrepancy exists in operation 210, the process moves to operation 220, where the user chooses the standard discrepancy for the discrepancy intended to be deleted. It may also be appropriate to pick a standard discrepancy that is close to the required discrepancy.

From operation 220, the process moves to operation 222, where the ADCS automatically populates the related data. More specifically, when a standard discrepancy is chosen from the standard discrepancy list, the remaining discrepancy information is populated based on the pre-determined data relationships for this standard discrepancy.

From operation 222, the process moves to operation 224, where it is determined whether the data is accurate. More specifically, if the related data is not accurate for the particular discrepancy being written, the process moves to operation 222, where the user may manually modify the data by, for example, choosing an item from the appropriate dropdown list, or typing the data in the appropriate text box.

If the data is accurate in operation 224, the process moves to operation 214.

With the embodiment of the present invention in FIG. 6, material information for a particular discrepancy is not duplicated. However, the present invention is not limited to such an embodiment.

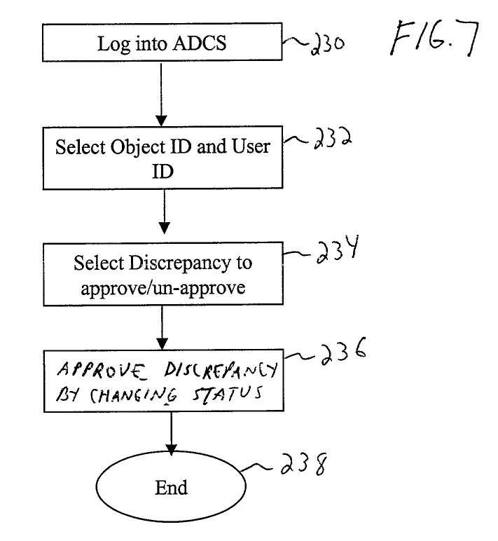

FIG. 7 is a diagram illustrating the approve/un-approve discrepancy information process 50 in FIG. 2, according to an embodiment of the present invention. The approve/un-approve discrepancy information process 50 can be executed by end-item module 22 and component module 24. The approve/un-approve discrepancy information process 50 would typically be restricted to those users who would normally approve work to be done on a respective object as a result of an individual discrepancy.

Referring now to FIG. 7, in operation 230, the user logs into the ADCS.

From operation 230, the process moves to operation 232, where the user enters a user ID and an object ID. The user is then presented with a list of all objects on which Examination and Evaluation Personnel have written discrepancies that have not yet been approved. For example, the ADCS presents a list of all un-approved discrepancies for the chosen object.

From operation 232, the process moves to operation 234, where the user selects a discrepancy from the presented list to approve/un-approve.

From operation 234, the process moves to operation 236, where the user approves the selected discrepancy by changing its status. For example, the user (who is an approving manager for discrepancies on the list) selects the discrepancy he/she wishes to approve, and changes the status of the discrepancy to “Approved”. In a typical embodiment, the user can repeat operations 234 and 236 for as many discrepancies as he/she wishes to approve.

From operation 236, the process moves to operation 238, where the process ends.

Once a discrepancy has been approved in FIG. 7, the discrepancy may no longer be modified or deleted. Such operation can be understood by referring, for example, to operation 148 in FIG. 4 and operation 180 in FIG. 5.

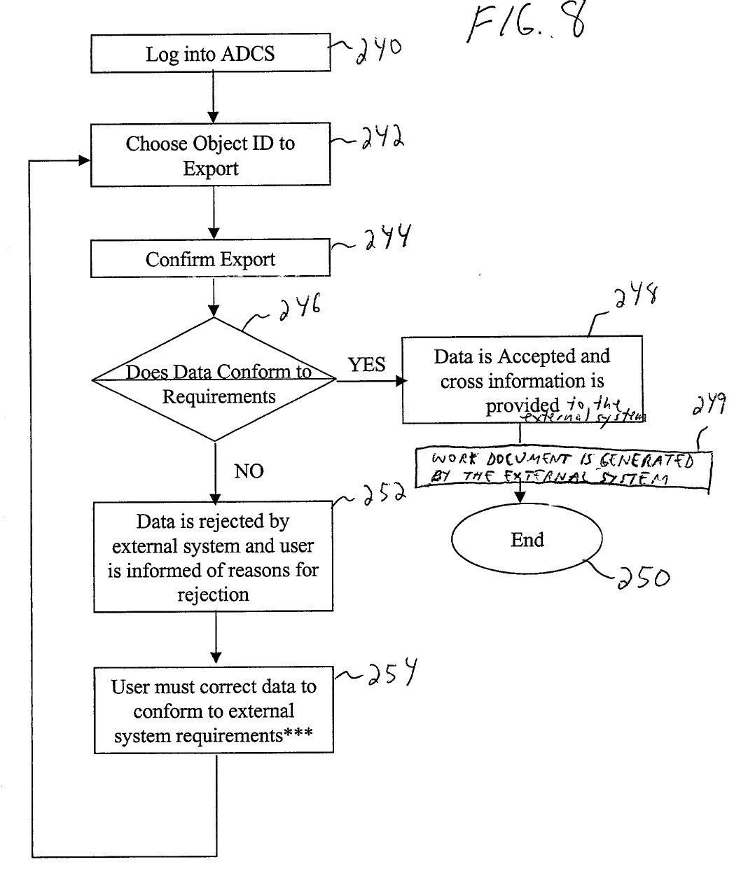

FIG. 8 is a diagram illustrating the operation of the export process 66 in FIG. 2 for exporting end-item discrepancy information and component discrepancy information to work packaging system 60, according to an embodiment of the present invention. The use of export process 66 would typically be restricted to those users who would normally approve work to be done on an object as a result of an individual discrepancy.

Referring now to FIG. 8, in operation 240, the user logs into the ADCS.

From operation 240, the process moves to operation 242, where the user chooses an object ID of an object for which data will be exported to an external system.

From operation 242, the process moves to operation 244, where the user confirms that the data is to be exported.

From operation 244, the process moves to operation 246, where the ADCS determines whether the data to be exported conforms to the requirements of the external system.

If the data conforms to the requirements of the external system, the process moves to operation 248, where the data is accepted by the external system and cross information is also provided to the external system.

From operation 248, the process moves to operation 249, where a work document is automatically generated by the external system. Here, the term “automatically” indicates that the work order is generated by a computer with the data exported to the external system.

From operation 249, the process moves to operation 250, where the process ends.

In operation 246, if the data does not conform to the requirements of the external system, the process moves to operation 252, where the data is rejected by the external system and the user is informed of reasons for the rejection.

From operation 252, the process moves to operation 254, where the user must correct the data to conform to the external system requirements.

From operation 254, the process returns to operation 242.

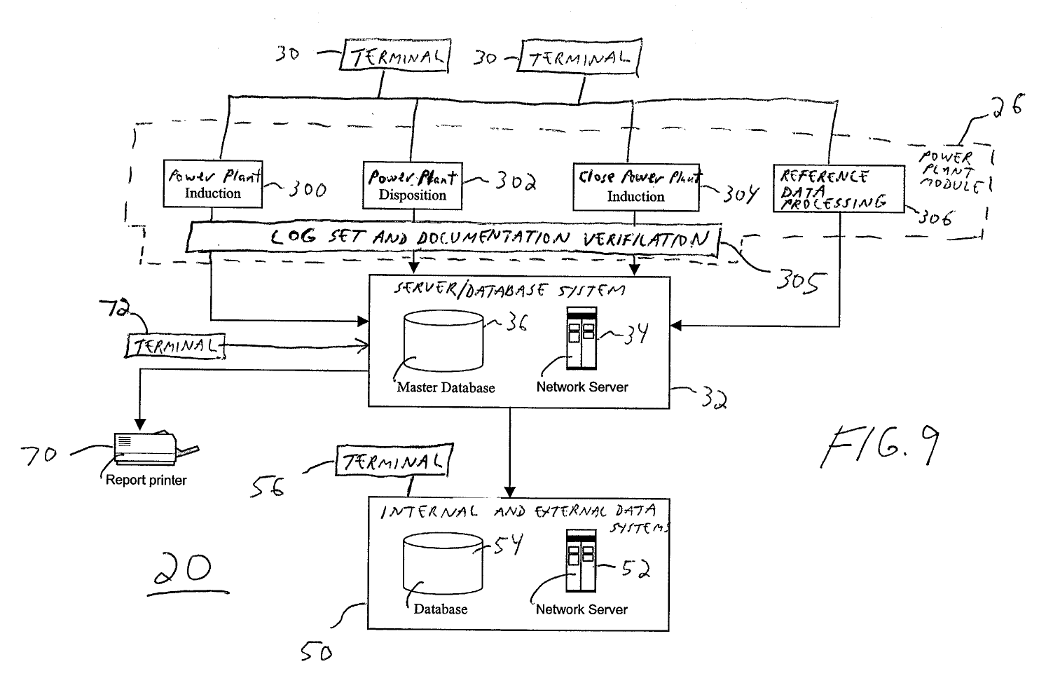

FIG. 9 is a diagram illustrating details of power plant module 26 (see FIG. 1) of ADCS 20, according to an embodiment of the present invention. Referring now to FIG. 9, users access terminals 30 to examine and evaluate discrepancy and related engineering data. As previously described, each terminal 30 might be, for example, a desktop computer, a mobile computer, a palm-type device, or some other type of terminal. Therefore, in a typical embodiment, each user might have his/her own mobile computer operating as terminal 30. Although FIG. 9 shows only two terminals, the present invention is not limited to any particular number of terminals or any particular number of users. Therefore, there might be a plurality of users having a plurality of terminals 30, respectively. The plurality of terminals 30 might include various desktop computers, mobile computers, palm-type devices and/or other types of terminals.

Via terminal 30, a user can access server/database system 32 to execute various processes. Such processes include, for example, a power plant induction process 300, a power plant disposition process 302, a close power plant induction process 304 and a reference data processing process 306. Power plant induction process 300, power plant disposition process 302 and close power plant induction process 304 operate in conjunction with a log set and documentation verification process 305.

Power plant module 26 is significantly different from end-item module 22 or component module 24 as a result of the process used to inspect power plants. During the induction, an inspection record is created for every part contained within the power plant object that must be inspected. Each of these records must be annotated with inspection data before the inspection is considered complete. This contrasts with end-item module 22 and component module 24 in that inspection records for end-items and components are only created if a defect is discovered.

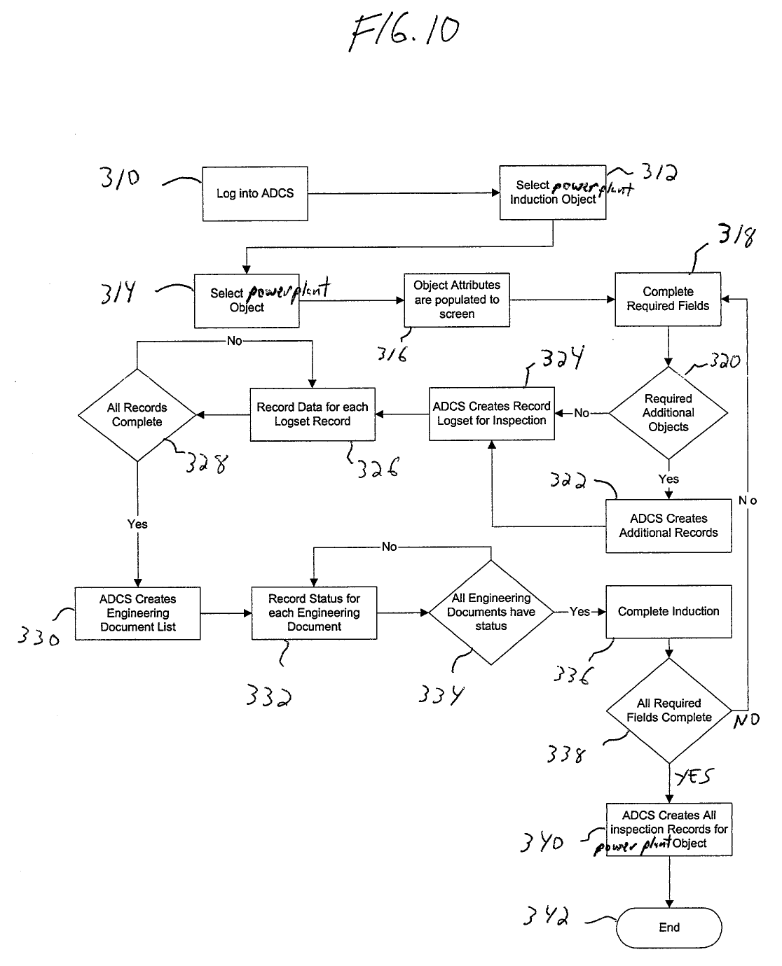

FIG. 10 is a diagram illustrating the power plant induction process 300 in FIG. 9, according to an embodiment of the present invention. The induction object describes the part level of the inspection object. In the present embodiment of power plant module 26, these part levels are, for example, “Engine”, “Module” or “Part”, each of which may contain several parts. Of course, the present invention is not limited to any specific levels. When the induction is complete, there will exist an inspection record for each of the parts within the part level that require an inspection.

Referring now to FIG. 10, in operation 310, the user logs into the ADCS using, for example, a User ID and Password.

From operation 310, the process moves to operation 312, where the user selects the power plant induction object.

From operation 312, the process moves to operation 314, where the user selects the power plant object of the selected power plant induction object. More specifically, the user indicates which part level he/she wishes to induct, and is prompted with data choices based on the choice they have made for the part level of the power plant. For example, if the user chose the “Engine” part level, the ADCS would create a list of all of the engine types contained within the ADCS reference table.

From operation 314, the process moves to operation 316, where the ADCS populates the object attributes to the user's screen. More specifically, data associated with the choices that the user has made concerning the object type and specific object is auto-populated in the data entry screen.

From operation 316, the process moves to operation 318, where the user completes the required fields. For example, the user may be required to fill out remaining data, some of which is required and some of which is optional. In some cases, dependant on the choices that the user has made, further data is required, that is not otherwise mandatory. The user is now required to fill in this additional data prior to moving to the next step of the process.

From operation 318, the process moves to operation 320, where the ADCS determines whether additional objects are required. If additional objects are required, the process moves to operation 322, where the ADCS creates these additional records.

From operation 322, the process moves to operation 324. Also, if no additional objects are required in operation 320, the process moves from operation 320 to operation 324.

In operation 324, the ADCS creates a record Log Set for inspection. More specifically, once the appropriate data has been entered, the ADCS creates a temporary set of inspection records, one for each inspected part of the object the user has inducted. These records, the Log Set, are created from the Bill of Materials, a reference table held within the ADCS, and contain basic information on all of the parts that could be inspected on this object.

The administrative personnel should exclude any parts that are not part of the specific object currently being inspected. For example, an object may have only one of three different parts. All three of these parts are listed as inspected parts in the temporary Log Set. The user must exclude the parts that are not included in the inspection of this particular object.

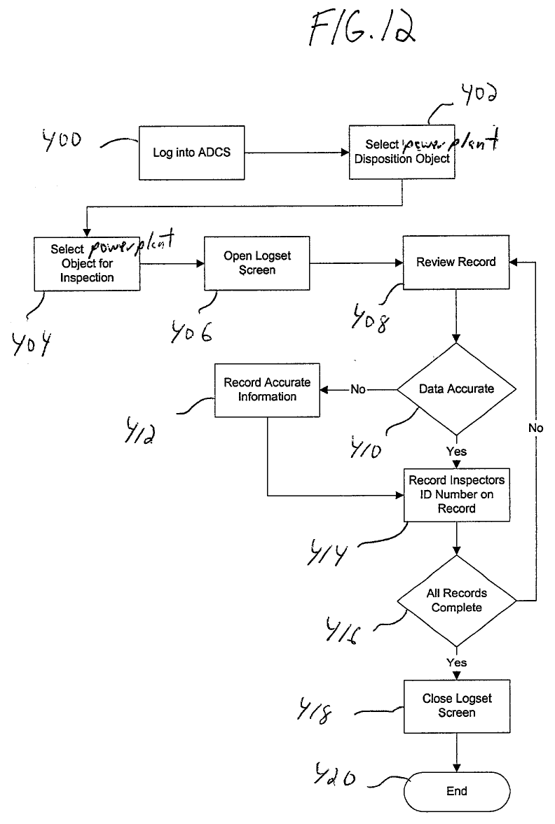

The Bill of Materials may also include parts that do not require inspection, such as small or structurally insignificant parts. These items are not shown in the temporary Log Set, but may be added during the disposition process (see FIG. 12).

Some of the inspected parts may be tracked parts. These parts would typically require the verification of particular identifying numbers such as serial numbers and part numbers on the part being inspected. The verification of these values is done during the disposition stage.

From operation 324, the process moves to operation 326, where data is recorded for each Log Set record. More specifically, the user must annotate the Log Set, and exclude any unnecessary records to complete the Log Set Verification.

From operation 326, the process moves to operation 328, where the ADCS determines whether all records are complete. If all records are not complete, the process returns to operation 326. If all records are complete, the process moves to operation 330.

In operation 330, the ADCS creates an Engineering Document list based on the temporary Log Set data and the Engineering Document List reference table.

From operation 330, the process moves to operation 332, where the ADCS records the status for each Engineering Document.

From operation 330, the process moves to operation 334, where the ADCS determines whether all Engineering Documents have a status. More specifically, for each part in the Log Set, the ADCS determines whether there are any associated Engineering Documents for the inspection of the part. The user must review and annotate the resulting list of documentation. If all Engineering Documents do not have a status in operation 334, the process returns to operation 332.

If all Engineering Documents have a status in operation 334, the process moves to operation 336, where the induction is completed.

From operation 336, the process moves to operation 338, where it is determined whether all required fields are completed. More specifically, when the administrative user has completed his/her induction, he/she approves the induction. The approval process performs a data validation check to make sure that all of the necessary data fields are complete, and that the data fits the business rules as programmed into the ADCS. If data is not complete or correct, the user will be asked to verify the data.

If all required fields are not complete in operation 338, the process returns to operation 318. If all required fields are complete in operation 338, the process moves to operation 340.

In operation 340, the ADCS creates all inspection records for the power plant object. More specifically, once all data is complete, and the approval is granted, the temporary Log Set and Engineering Document List are transformed into permanent lists that will be used to perform the inspection of the power plant object.

From operation 340, the process moves to operation 342, where the process ends.

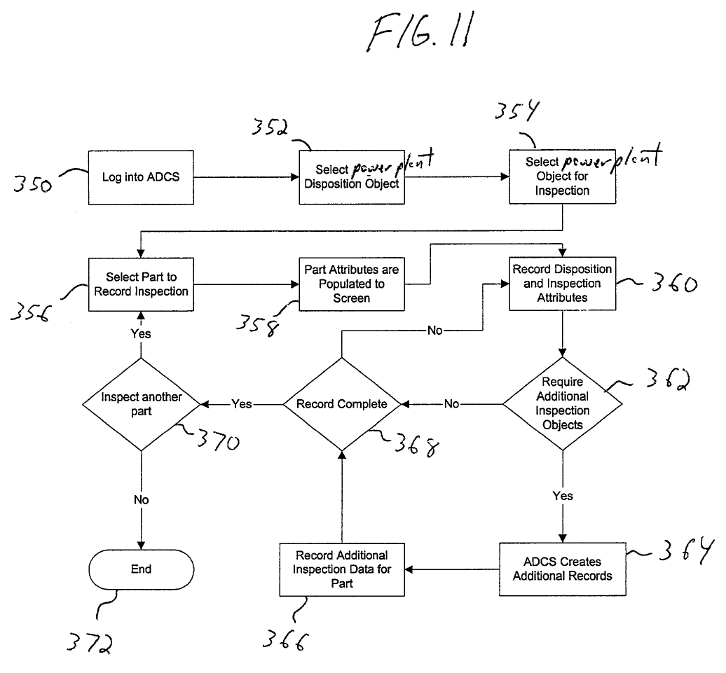

FIG. 11 is a diagram illustrating the power plant disposition process 302 in FIG. 9, according to an embodiment of the present invention. Referring now to FIG. 11, in operation 350, the user logs into the ADCS using, for example, a User ID and Password.

From operation 350, the process moves to operation 352, where the user selects the power plant disposition object.

From operation 352, the process moves to operation 354, where the user selects the power plant object of the selected power plant disposition object. More specifically, the user indicates which part level he/she wishes to inspect, and is prompted with data choices based on the choice they have made for the part level of the power plant. For example, if the user chose the “Engine” part level, the ADCS would create a list of all of the engine types contained within the ADCS references.

The user is now presented with a hierarchical tree view of the selected part, and all of its sub-parts. The tree view provides a navigation tool and a status tool.

As a navigation tool, the tree view provides a list of all of the sub-parts of the part chosen to inspect. Each sub-part is a level below its parent level. The user may drill down through the tree view to go directly to the specific part, corresponding to the records in the Log Set, that he/she wishes to inspect. As a status tool, the tree view indicates through a user-friendly set of graphics, whether or not the specific part has been completely inspected, partially inspected, or not inspected at all.

From operation 354, the process moves to operation 356, where the user selects a part for which to record an inspection. When the user chooses the specific part from the tree view, the part information is presented as seen in the Log Set.

From operation 356, the process moves to operation 358, where the ADCS populates the object attributes to the user's screen. More specifically, data associated with the choices that the user has made concerning the object type and specific object is auto-populated in the data entry screen.

From operation 358, the process moves to operation 360, where disposition and inspection attributes are recorded. The user can now perform the inspection of the part and fill in the required information.

From operation 360, the process moves to operation 362, where the ADCS determines whether any additional inspection objects are required. If additional inspection objects are required in operation 362, the process moves to operation 364, where the ADCS creates the additional records.

From operation 364, the process moves to operation 366, where additional inspection data for the additional parts are recorded

From operation 366, the process moves to operation 368. Moreover, if no additional inspection objects are required in operation 362, the process moves from operation 362 to operation 368.

In operation 368, it is determined whether the records are complete. If the records are not complete, the process returns to operation 360. If the records are complete in operation 368, the process moves to operation 370.

In operation 370, it is determined whether there is another part to inspect. If there is another part to inspect, the process returns to operation 356. If there is not another part to inspect, the process moves from operation 370 to operation 372, where the process ends.

Certain measurement data can be collected for certain parts. The measurement boundary data is obtained from the ADCS measurement reference table based on the part being inspected. When the user enters the current measurement data, the ADCS calculates the pass/fail state of the part being measured.

New measurement data can also be entered for parts that have no measurement data listed in the measurement reference table. In this case, the user may be required to manually enter the boundary data in order to calculate the pass/fail determination.

FIG. 12 is a diagram illustrating the Log Set verification process 305 in FIG. 9, according to an embodiment of the present invention. Generally, the Examination and Evaluation personnel review the verification performed by the Administrative Personnel in the induction. More specifically, the Examination and Evaluation personnel review each record, and record their User ID on each verified record. Each record must be verified for the object inspection to be considered complete, and ready for close out.

Referring now to FIG. 12, in operation 400, the user logs into the ADCS using, for example, a User ID and Password.

From operation 400, the process moves to operation 402, where the user selects the power plant disposition object.

From operation 402, the process moves to operation 404, where the user selects the power plant object of the selected power plant disposition object.

From operation 404, the process moves to operation 406, where a Log Set screen is opened.

From operation 406, the process moves to operation 408, where the record for the selected power plant object is reviewed

From operation 408, the process moves to operation 410, where the user determines whether the data is accurate. If the data is not accurate in operation 410, the process moves to operation 412, where accurate information is recorded. From operation 412, the process moves to operation 414. If the data is accurate in operation 410, the process moves to operation 414.

In operation 414, the inspector's ID number is recorded in the record.

From operation 414, the process moves to operation 416, where it is determined whether all the records are complete. If all the records are not complete in operation 416, the process returns to operation 408. If all the records are complete in operation 416, the process moves to operation 418.

In operation 418, the Log Set screen is closed.

From operation 418, the process moves to operation 420, where the process ends.

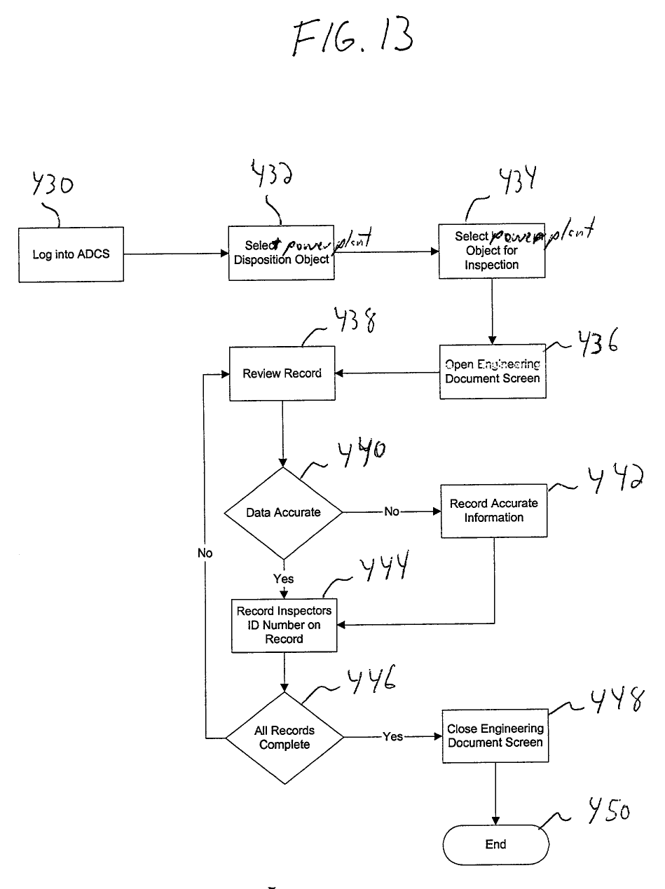

FIG. 13 is a diagram illustrating a documentation verification process 305 in FIG. 9, according to an embodiment of the present invention. Generally, FIG. 13 depicts verification of the Engineering Documentation. The Examination and Evaluation Personnel must review the verification performed by the Administrative Personnel in the induction.

Referring now to FIG. 13, in operation 430, the user logs into the ADCS using, for example, a User ID and Password.

From operation 430, the process moves to operation 432, where the user selects the power plant disposition object.

From operation 432, the process moves to operation 434, where the user selects the power plant object of the selected power plant disposition object for inspection.

From operation 434, the process moves to operation 436, where an Engineering Document screen is opened.

From operation 436, the process moves to operation 438, where a record for the selected power plant object is reviewed.

From operation 438, the process moves to operation 440, where it is determined whether the data is accurate. If the data is not accurate in operation 440, the process moves to operation 442, where accurate information is recorded. From operation 442, the process moves to operation 444. In operation 440, if the data is accurate, the process moves to operation 444.

In operation 444, the inspector's ID number is recorded on the record.

From operation 444, the process moves to operation 446, where it is determined whether all records are complete. If all records are not complete in operation 446, the process returns to operation 438. If all records are complete in operation 446, the process moves to operation 448, where the Engineering Document screen is closed.

From operation 450, the process moves to operation 450, where the process ends.

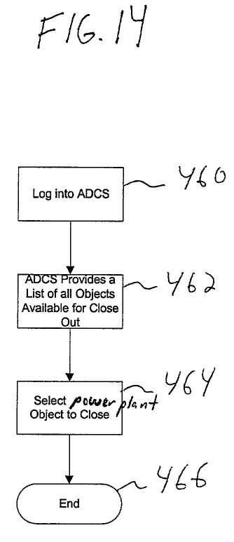

FIG. 14 is a diagram illustrating operation of the close power plant induction process 304 in FIG. 9, according to an embodiment of the present invention. Generally, once the Examination and Evaluation Personnel have completed their inspection, they must close out the inducted item.

Referring now to FIG. 14, in operation 460, the user logs into the ADCS.

From operation 460, the process moves to operation 462, where the ADCS provides a list of all objects available for close out. In order to qualify for a close out, the disposition, Log Set, and Engineering Documentation records must all be complete. If the object that the user wishes to close out is not in the list provided, this indicates that the object inspection is not yet complete.

From operation 462, the process moves to operation 464, where the user selects power plant objects to close, and then these selected object objects are closed.

From operation 464, the process moves to operation 466, where the process ends.

In the above embodiments of the present invention, all reference data is populated during the implementation of the ADCS. More specifically, this data is cross-referenced with standard discrepancy data such that when the user selects a standard discrepancy, the cross-referenced data is auto-populated, and pre-validated.

According to above embodiments of the present invention, an ADCS includes terminals located in an inspection vicinity of an end-item formed of different components. The terminals might be fixed in the inspection vicinity (for example, as a desktop computer might be relatively stationary at the inspection vicinity), or might be mobile terminals taken with the inspectors around the end-item to the components being inspected. The inspectors inspect the components and enter resulting inspection data into the terminals. The entered inspection data from each of the inspectors is electronically transferred to a database system, which correlates and maintains inspection data for the end-item.

For example, in FIG. 2, master database 36, together with the any required hardware/software, operates as a database system correlating and maintaining the inspection data. Database systems are well-known, and the present invention is not limited to any particular type of database system.

As indicated above, the inspectors enter inspection information into terminals at the inspection vicinity. Generally, the inspection vicinity refers to the physical area around a component being inspected. Generally, the size of the inspection vicinity would depend on the size or location of the end-item. For example, if the end-item is an airplane, the inspection vicinity might be a large room or outside area in which the airplane is located, or where the inspected component is located. If the end-item is a smaller item, such as an automobile, the inspection vicinity might be within a few feet of the component being inspected. Generally, the inspection vicinity is an appropriate area where the terminal is located so that an inspector can enter information in the terminal while the inspection is being conducted.

In some circumstances, the inspection vicinity would be a place where inspectors normally congregate near the end-item or component to enter the inspection data due to size of the end-item or component, or safety issues. For example, if the end-item was a military tank and the inspector had to crawl into a small space to inspect a component of the tank, the inspection vicinity might be an area outside the tank, or a room near the tank, where the inspector can enter data into the terminal after exiting the small space.

According to the above embodiments of the present invention, the ADCS tracks discrepancy data electronically, providing clear, concise and easy to read characters. The ADCS provides more in the way of standard and agreed upon annotations, decreasing the potential for the misinterpretation of data. The ADCS maintains reference data, and will not allow the user to enter values that are not part of the standard reference data set as outlined by the standards body. Thus, data is consistent throughout the life of the inspection program.

Further, the ADCS electronically sends captured data to a Work Document generation application, significantly decreasing the amount of time necessary to commence work on the defects. The ADCS, through one-time, prior research, already contains this information for standard discrepancies, allowing the Examination and Evaluation Personnel to spend more time inspecting an End-Item, and less time searching for data on standard discrepancies. The ADCS collects and maintains historical reference data, and can run standard reports from this data in minutes. The time taken to create reports is decreased significantly. The ADCS allows for the electronic transfer of data to both internal and external systems, and for the review of ADCS data by multiple people at any given time.

The ADCS is typically installed on a mobile computing device that can be taken to the object for immediate data entry. The ADCS data entry process was created with the assistance of Examination and Evaluation Personnel, and reflects how they inspect the object for which they are responsible. Examination and Evaluation Personnel enter all inspection data on a single data entry screen that is structured to take advantage of Lateral Thinking Methodology. This methodology allows each Examination and Evaluation staff member to input data in their own fashion, giving them the freedom to inspect the object in the manner that best fits their own work style.

An automated discrepancy and condition data collection and reporting system, such as the ADCS, that is fast, efficient, accurate, and targeted to the language of the user and to the type of user operating the system, will greatly increase the efficiency and reliability of the inspection process.

In above embodiments of the present invention, an end-item is described as being an aircraft. However, an end-item is not limited to being an aircraft. Instead, an end-item an be virtually any type of object being inspected. For example, an end-item could be virtually any type of vehicle, vessel, power plant, mechanical system, electrical system, etc. An end-item could even be a simply manufactured item with relatively few components.

Accordingly, the present invention provides three different software modules to provide maintenance data collection for complete end-item inspection, power plant inspection and component inspection. The present invention can be adapted to any object, large or small, such as aircraft, sea-going vessels, ground vehicles, or any inventory of equipment such as electronic analysis tools, weapon systems or repair equipment.

The present invention provides a flexible data entry process to the Examination and Evaluation Personnel through the use of the Lateral Thinking Methodology. The Lateral Thinking Methodology is a set of systematic techniques used for changing concepts and perceptions, and generating new ones. This concept was used to create the most flexible system possible for the ease of use of the Examination and Evaluation Personnel.

The present invention provides accurate data validation and maintains data integrity. Data validation is performed according to the data requirements and business rules of the client organization and of the standard inspection specifications.

The present invention allows for different data perspectives for different user types. Each user type may view data in a perspective that is conducive to the tasks assigned to that user.

The present invention allows the approval of work to be completed for financial management purposes.

The present invention allows administrative staff to maintain all reference data that is to be provided to the Examination and Evaluation Personnel through dropdown lists.

Moreover, the present invention ensures the security integrity of the data collected by and assigned to the Examination and Evaluation Personnel.

The present invention provides historical maintenance data to internal and external Information Technology systems. This allows for internal and external systems to analyze maintenance data and to alter existing related processes, such as purchasing or manufacturing, according to accurate historical data.

The present invention rapidly and effectively creates analysis reports to be electronically or manually distributed to internal and external systems, such as internal engineering departments, suppliers, customers, or standards bodies, on demand.

The present invention archives historical maintenance data for future extraction and analysis.

The present invention provides the user with a graphical user interface that is easy to use, complete and in line with the Lateral Thinking Methodology. The present invention provides relevant data choices to the user, dependant on all data previously entered by the user. These data elements will change dynamically with every piece of data that the user enters.

The present invention can be implemented on a desktop computer or a mobile computing unit in a standalone environment or attached to a Local Area Network or Wide Area Network (such as, for example, the Internet) via hardwired or wireless networking technology.

The present invention allows users to access any previously written discrepancy at any time.

The present invention accepts electronic data input from any electronic input device, such as, but not limited to, electronic measuring devices, visual or audio recording devices, bar code reading devices, optical scanning devices, and micro-button reading devices.

An embodiment of the present invention provides an automated method by which discrepancy data and related engineering data is developed, captured, transferred, and reported during the examination and evaluation of aircraft, aircraft engines, and aircraft components undergoing repair in an aviation maintenance environment.

The present invention provides three separate and distinct applications for each of the three modules: End-item Inspection (i.e.: Aircraft), Power Plant Inspection (i.e.: Aircraft Engines), and Component Inspection (i.e.: Aircraft subsystems).

The present invention employs Lateral Thinking Methodology, and provides a collection of interlocked dropdown lists to assist a object examiner, including but not limited to an aircraft examiner, to record the location, type, and extent of discrepancies found on an object during a typical examination and evaluation process. The choices available to the user in a given dropdown list are tailored based upon the physical configuration of the object being inspected, the type of inspection, the inspection category under which the inspection is being performed, and the selections made in all previous dropdown lists. This methodology allows each type of inspector to proceed through the inspection following his or her own process, without the data capture application dictating a step-by-step process.

Lateral Thinking Methodology is described by Dr. Edward de Bono in “Lateral Thinking: Creativity Step by Step”, published in New York by Harper and Row Publishers, copyrighted in 1970, which is incorporated herein by reference. The use of the Lateral Thinking Methodology allows the present invention to be flexible and extremely easy to use. The user chooses what order they wish to input most of the data, and all inspection data can be entered using dropdown lists.

Various embodiments of the present invention can operate on both desktop and mobile computer platforms, in a standalone environment or connected through wired or wireless networking technology to a server, enabling Examination and Evaluation Personnel to move freely about the object during the Examination and Evaluation Process.

The present invention presents a set of standard reference data that is collected and entered into a set of data tables during the implementation of the product. The data in these tables can be, and in some cases must be, continuously updated by the user, through administrative functionality built into the product.

The present invention offers users a set of standard discrepancies, as collected and populated during the implementation of the product. The user, through the administrative functionality built into the product, can continuously update these standard discrepancies.

The present invention offers data validation to increase data reliability and integrity. Upon the saving of a record, each piece of data entered by the user is validated against the standard set of reference data and business rules, as already developed into the ADCS. Required data is tested for and the user is not allowed to proceed without entering this data.

The present invention relates to information being “electronically” transmitted. Generally, this indicates that the information is stored in a computer readable format that can be transmitted to and from a computer by a computer communication channel. The present invention is not limited to any particular underlying technology for implementing such a computer communication channel. For example, the computer communication channel might use wireless, wired, electrical or optical communication technology.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An automated data capture system comprising:
terminals located in an inspection vicinity of an end-item formed of different components, inspectors inspecting the components and entering resulting inspection data into the terminals; and
a database system, the entered inspection data from each of the inspectors being electronically transferred to the database system and correlated and maintained by the database system as inspection data for the end-item.

2. A system as in claim 1, wherein the terminals are mobile terminals, each inspector taking a respective mobile terminal with the inspector to a inspection vicinity of each component being inspected by the inspector so that the inspector can enter inspection data directly into the terminal as the inspector inspects the component.

3. A system as in claim 1, further comprising:
a computer-implemented information adder allowing inspectors to select a component for which inspection data will be entered, thereby allowing the inspectors to select the order in which components will be inspected.

4. A system as in claim 3, wherein, after a respective inspector selects a component for which inspection data will be entered, the information adder automatically provides an electronically selectable list of standard discrepancies for the selected component to the inspector, the inspector then electronically selecting a standard discrepancy from the list to thereby enter the standard discrepancy as inspection data indicating that the standard discrepancy was found during the inspection by the inspector of the selected component.

5. A system as in claim 1, further comprising:
a computer-implemented information modifier allowing inspectors to access previously entered inspection data maintained by the database system and modify the accessed inspection data.

6. A system as in claim 5, wherein the information modifier is operable by the inspectors from the terminals.

7. A system as in claim 5, wherein, to access previously entered inspection data, the information modifier allows inspectors to select a component for which previously entered inspection data will be modified, thereby allowing different inspectors to modify different previously entered inspection data and allowing the order in which components are selected to be determined by the inspectors.

8. A system as in claim 7, wherein inspectors are not allowed to modify previously inspected inspection data that is currently approved by an authorized approver.

9. A system as in claim 1, further comprising:
a computer-implemented information viewer allowing inspectors to electronically view previously entered inspection data maintained by the database system.

10. A system as in claim 9, wherein the information viewer is operable by the inspectors from the terminals.

11. A system as in claim 9, wherein, to view previously entered inspection data, the information viewer allows inspectors to select a component for which previously entered inspection data will be viewed, thereby allowing different inspectors to view different previously entered inspection data and allowing the order in which components are selected to be determined by the inspectors.

12. A system as in claim 1, further comprising:
a computer-implemented information deleter allowing inspectors to access previously entered inspection data maintained by the database system and delete the accessed inspection data.

13. A system as in claim 12, wherein the information deleter is operable by the inspectors from the terminals.

14. A system as in claim 12, wherein, to access previously entered inspection data, the information deleter allows inspectors to select a component for which previously entered inspection data will be deleted, thereby allowing different inspectors to delete different previously entered inspection data and allowing the order in which components are selected to be determined by the inspectors.

15. A system as in claim 12, wherein inspectors are not allowed to delete previously inspected inspection data that is currently approved by an authorized approver.

16. A system as in claim 1, further comprising:
a computer-implemented information duplicator allowing inspectors to access previously entered inspection data maintained by the database system and duplicate the accessed inspection data.

17. A system as in claim 16, wherein the information duplicator is operable by the inspectors from the terminals.

18. A system as in claim 16, wherein, to access previously entered inspection data, the information duplicator allows inspectors to select a component for which previously entered inspection data will be duplicated, thereby allowing different inspectors to duplicate different previously entered inspection data and allowing the order in which components are selected to be determined by the inspectors.

19. A system as in claim 1, further comprising:
a computer-implemented authorizer allowing an authorizer to electronically access the inspection data maintained by the database system, and electronically authorize the maintained data.

20. A system as in claim 1, further comprising:
an exporter electronically exporting the inspection data for the end-item from the database system to a work order system which automatically generates work orders from the exported data.

21. An automated data capture system comprising:
a first mobile terminal for a first inspector, the first inspector inspecting components of an end-item in an order selectable by the first inspector, inspection of a respective component by the first inspector resulting in inspection data which is directly entered into the first mobile terminal in an inspection vicinity of the component by the first inspector;
a second mobile terminal for a second inspector, the second inspector inspecting components of the end-item in an order selectable by the second inspector, inspection of a respective component by the second inspector resulting in inspection data which is directly entered into the second mobile terminal in an inspection vicinity of the component by the second inspector; and
a database system, the entered inspection data from the first and second inspectors being electronically transferred to the database system and correlated and maintained by the database system as inspection data for the end-item.

22. A system as in claim 21, further comprising:
a computer-implemented information adder allowing the first and second inspectors to select a component for which inspection data will be entered, thereby allowing the first and second inspectors to select the order in which components will be inspected.

23. A system as in claim 22, wherein, after a respective inspector of the first and second inspectors selects a component for which inspection data will be entered, the information adder automatically provides an electronically selectable list of standard discrepancies for the selected component to the respective inspector, the respective inspector then electronically selecting a standard discrepancy from the list to thereby enter the standard discrepancy as inspection data indicating that the standard discrepancy was found during the inspection by the respective inspector of the selected component.

24. A system as in claim 21, further comprising:
an exporter electronically exporting the inspection data for the end-item from the database system to a work order system generating work orders from the exported data.

25. An automated data capture system comprising:
an information adder;
a first mobile terminal for a first inspector, the first mobile terminal operable with the information adder to allow the first inspector to select a component of an end-item for which the first inspector will enter inspection data while in an inspection vicinity of the selected component, wherein, after the first inspector selects a component, the information adder automatically provides an electronically selectable list of standard discrepancies for the selected component to the first inspector via the first mobile terminal, the first inspector then electronically selecting a standard discrepancy from the list while in the inspection vicinity to thereby enter the standard discrepancy as inspection data indicating that the standard discrepancy was found during an inspection of the selected component;
a second mobile terminal for a second inspector, the second mobile terminal operable with the information adder to allow the second inspector to select a component of the end-item for which the second inspector will enter inspection data while in an inspection vicinity of the selected component, wherein, after the second inspector selects a component, the information adder automatically provides an electronically selectable list of standard discrepancies for the selected component to the second inspector via the second mobile terminal, the second inspector then electronically selecting a standard discrepancy from the list while in the inspection vicinity to thereby enter the standard discrepancy as inspection data indicating that the standard discrepancy was found during an inspection of the selected component; and
a database system, the entered inspection data from the first and second inspectors being electronically transferred to the database system and correlated and maintained by the database system as inspection data for the end-item.

26. A system as in claim 25, further comprising:
an exporter electronically exporting the inspection data for the end-item from the database system to a work order system generating work orders from the exported data.

27. A system as in claim 25, further comprising:
a computer-implemented information modifier allowing the first inspector to access, via the first mobile terminal, previously entered inspection data maintained by the database system and to modify the accessed inspection data, and allowing the second inspector to access, via the second mobile terminal, previously entered inspection data maintained by the database system and to modify the accessed inspection data.

28. A system as in claim 26, further comprising:
a computer-implemented information modifier allowing the first inspector to access, via the first mobile terminal, previously entered inspection data maintained by the database system and to modify the accessed inspection data, and allowing the second inspector to access, via the second mobile terminal, previously entered inspection data maintained by the database system and to modify the accessed inspection data.

29. A system as in claim 25, wherein reference data is cross-referenced with standard discrepancy data so that, when a respective inspector selects a standard discrepancy, the cross-referenced data is auto-populated and then displayed on the respective terminal of the inspector.

30. An automated data capture system comprising:
an information adder;
a first terminal for a first inspector, the first terminal operable with the information adder to allow the first inspector to select a component of an end-item for which the first inspector will enter inspection data while in an inspection vicinity of the selected component, wherein, after the first inspector selects a component, the information adder automatically provides an electronically selectable list of standard discrepancies for the selected component to the first inspector via the first terminal, the first inspector then electronically selecting a standard discrepancy from the list while in the inspection vicinity to thereby enter the standard discrepancy as inspection data indicating that the standard discrepancy was found during an inspection of the selected component;
a second terminal for a second inspector, the second terminal operable with the information adder to allow the second inspector to select a component of the end-item for which the second inspector will enter inspection data while in an inspection vicinity of the selected component, wherein, after the second inspector selects a component, the information adder automatically provides an electronically selectable list of standard discrepancies for the selected component to the second inspector via the second terminal, the second inspector then electronically selecting a standard discrepancy from the list while in the inspection vicinity to thereby enter the standard discrepancy as inspection data indicating that the standard discrepancy was found during an inspection of the selected component; and
a database system, the entered inspection data from the first and second inspectors being electronically transferred to the database system and correlated and maintained by the database system as inspection data for the end-item.

31. A system as in claim 30, further comprising:
an exporter electronically exporting the inspection data for the end-item from the database system to a work order system generating work orders from the exported data.

32. A system as in claim 30, further comprising:
a computer-implemented information modifier allowing the first inspector to access, via the first terminal, previously entered inspection data maintained by the database system and to modify the accessed inspection data, and allowing the second inspector to access, via the second terminal, previously entered inspection data maintained by the database system and to modify the accessed inspection data.

33. A system as in claim 31, further comprising:
a computer-implemented information modifier allowing the first inspector to access, via the first terminal, previously entered inspection data maintained by the database system and to modify the accessed inspection data, and allowing the second inspector to access, via the second terminal, previously entered inspection data maintained by the database system and to modify the accessed inspection data.

34. A system as in claim 30, wherein reference data is cross-referenced with standard discrepancy data so that, when a respective inspector selects a standard discrepancy, the cross-referenced data is auto-populated and then displayed on the respective terminal of the inspector.
